(19) United States
(12) Patent Application Publication
(10) Pub. No.: US 2013/0339199 A1
(43) Pub. Date: Dec. 19, 2013

(54) INVENTORY EXCHANGE FOR MANAGING INVENTORY ACROSS MULTIPLE SALES CHANNELS

(71) Applicants: Mohan Patt, Hayward, CA (US); Nishant Asthana, San Jose, CA (US); Sachin Tilloo, Fremont, CA (US)

(72) Inventors: Mohan Patt, Hayward, CA (US); Nishant Asthana, San Jose, CA (US); Sachin Tilloo, Fremont, CA (US)

(73) Assignee: eBay Inc., San Jose, CA (US)

(21) Appl. No.: 13/495,703

(22) Filed: Jun. 13, 2012

(51) Int. Cl. G06Q 10/08

(52) U.S. Cl. 705/28

(57) ABSTRACT

A system, method, and computer readable medium are provided to manage an inventory across multiple sales channels. A first set of items from an inventory is listed on a first sales channel according to a business rule. A second set of items from the inventory is listed on a second sales channel according to the business rule. Order events from the first sales channel and the second sales channel are tracked. The order events may indicate a transaction involving an item from the inventory. The business rule may be used to rebalance items still offered for sale on the first sales channel and the second sales channel.

### TECHNICAL FIELD

This application relates to data processing. In particular, example embodiments may provide an inventory management system that manages an inventory across multiple sales channels.

### BACKGROUND

With rapid improvements in technology, methods and systems that enable commerce have changed and are rapidly evolving. For example, when it comes to traditional electronic commerce, merchants may sell items from their inventory not only through websites branded and controlled by the merchant but also through a multitude of third-party online marketplaces, such as eBay™ and Amazon™. In general, the advent of online marketplaces (or simply marketplaces) benefits customers. Such is the case because a marketplace provides customers with a view across multiple merchants. Where multiple merchants compete for the sale of an item, a customer may receive a comparatively better return in their purchase.

It is common for merchants to sell items of an inventory across multiple marketplaces. For example, merchants commonly partition items across multiple marketplaces so that there is no overlap in items. That is, the sum total of items listed on a set of marketplaces does not exceed the total items in the merchant's inventory. For example, a merchant may list items of an inventory total in marketplaces M1 and M2 such that:

T=TM1+TM2+T1

Where T is the total inventory the merchant is attempting to sell, TM1 is items from the inventory that are listed on M1, TM2 is items from the inventory that are listed on M2, and T1 is the remaining inventory on merchant's site and warehouse.

### BRIEF DESCRIPTION OF THE DRAWINGS

The present disclosure is illustrated by way of example, and not by way of limitation, in the figures of the accompanying drawings in which:

FIG. 1A is a network diagram depicting a transaction system, according to an example embodiment;

FIG. 1B is a network diagram depicting an event system, consistent with some embodiments described herein, configured to manage an inventory across multiple sales channels using an event driven architecture;

FIG. 2A is a block diagram illustrating a data flow to initiate an inventory management service across multiple sales channels, according to an example embodiment;

FIG. 2B is a block diagram illustrating a data flow for managing an inventory management service across multiple sales channels, according to an example embodiment;

FIG. 3 is a block diagram illustrating example modules and data of the inventory exchange, according to an example embodiment;

FIG. 4 is a flow chart illustrating a method of managing an inventory across multiple sales channels, according to an example embodiment;

FIG. 5 is a diagram that shows a number of conditions that may be used by example embodiments to determine whether to perform operation of FIG. 4;

FIG. 6 is a diagram showing various conditions used to update a business rule, according to an example embodiment; and

FIG. 7 shows a diagrammatic representation of machine in the example form of a computer system within which a set of instructions may be executed causing the machine to perform any one or more of the methodologies discussed herein.

### DETAILED DESCRIPTION

Although example embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense.

In one embodiment, a system and method provide an inventory management service that manages listings across multiple sales channels. The term “sales channel,” as used herein, may refer to a consumer-facing interface configured to sell a product or service to one or more customers. A sales channel can be direct if the sales channel is operated by the business selling the product or service to the customers (e.g., through a brick and mortar store or a branded website), or a sales channel can be indirect if an intermediary or third-party, such as a retailer, dealer, or online marketplace, operates the interface for selling the product or service to customers. By way of example and not limitation, an online marketplace (e.g., as may be offered by eBay™ or Amazon™) may offer online services for listing products or services for sales, as well as other activities used in completing a sale.

Consistent with some example embodiments disclosed herein, the inventory management system may provide an inventory management interface that allows a user (e.g., a seller) to manage aspects involved in managing an inventory across multiple sales channels. For example, the inventory management interface may be configured to allow the user to define one or more business rules associated with an inventory. A business rule may be logic and/or data that the inventory management system uses to distribute an inventory across multiple sales channels. For example, a business rule may indicate that an inventory is to be distributed across a first and second sales channel according to a 60-40 split. Accordingly, if the inventory includes 100 items, using the example business rule, the inventory management system may create or present 60 listings on the first sales channel and 40 listings on the second sales channel.

The inventory management system may provide a number of practical applications. For example, according to an example embodiment, the inventory management system may be configured to update the listings associated with each of the sales channels. For example, based on a determinable condition (e.g., a time period or inventory condition), the inventory management service may determine that the inventory is to be rebalanced across the multiple sales channels. Such rebalancing may occur, for example, if sales occurring on the first sales channels have caused the distribution of items listed on the first and second channels to deviate from the 60-40 split. In this case, the inventory management service may de-list listings from one sales channel and re-list those items on another sales channel until the distribution of items of an inventory is consistent with the business rule.

In some embodiments, the inventory management system may be configured to update an item listing based on a price comparison between multiple sales channels. For example, a merchant may configure a threshold price for items of an inventory that are sold on a specific sales channel. The inventory management system may then subscribe to multiple sales channels to receive price change events. Price change events may indicate a price change for similar items sold by competitor merchants. In one way, similarity is determined based on matching categories. When items are sold on the multiple sales channels, the inventory management system may receive price change events. The price change event may specify a new price of an item that is similar to the items of the inventory. Based on a price adjustment function, the inventory management system may adjust the price on the item listing. For example, the inventory management system may determine that the price specified by the price change event is more than the price threshold but less than the price of the listed item. In response to this determination, the inventory management system may update the listed item to reflect a new price that is a function of the price specified in the price change event (e.g., a price that is lower than the competition). This rule can be one of the triggers in a chain of configured rules in addition to time period and inventory condition mentioned above.

These and other embodiments are described in greater detail below.

### Platform Architecture

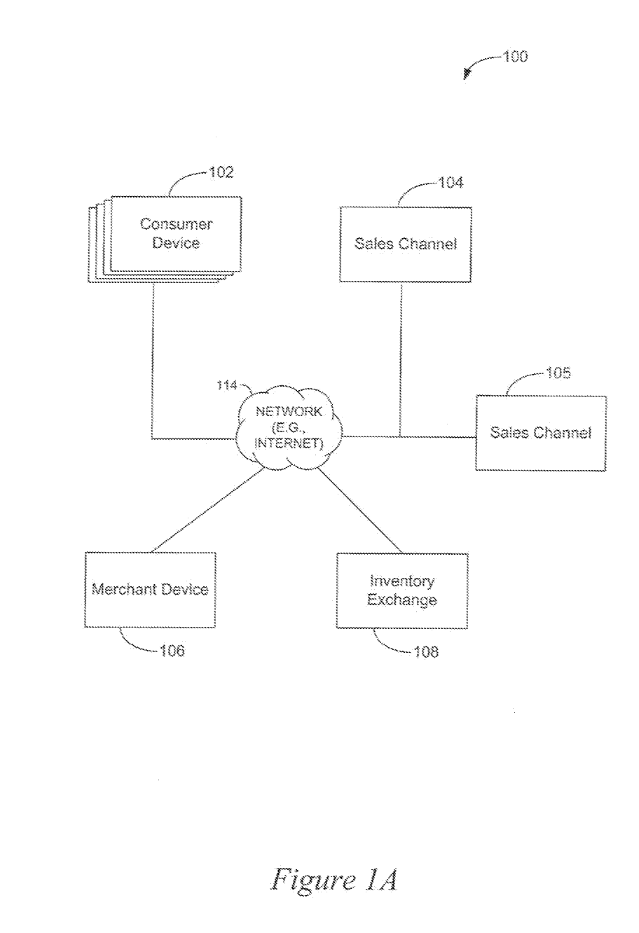

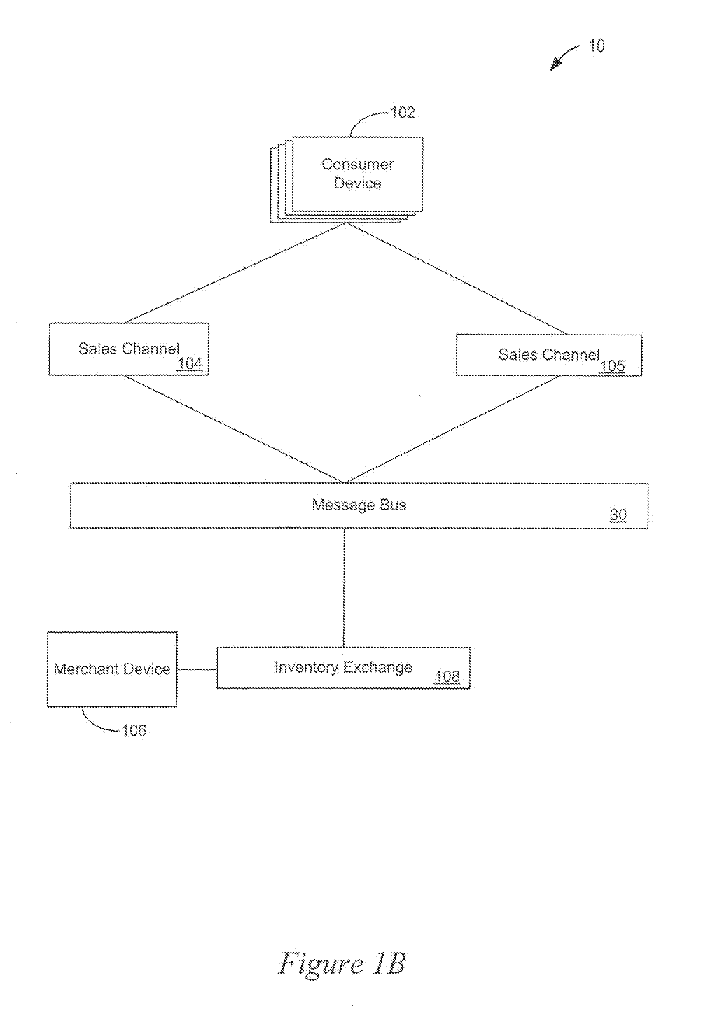

FIG. 1A is a network diagram depicting a transaction system 100, according to an example embodiment. According to FIG. 1A, the transaction system 100 includes consumer machine(s) 102, sales channels 104, 105, a merchant device 106, and an inventory exchange 108 communicatively coupled via a network 114. In some embodiments the transaction system 100 allows a merchant to configure one or more business rules that characterize a method for managing an inventory across multiple sales channels.

The network 114 may be any suitable network used to communicate data between the components shown in FIG. 1. In various embodiments, one or more portions of the network 114 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The sales channels 104, 105 may provide server-side functionality, via a network 114 (e.g., the Internet) to the consumer device 102. The sales channels 104, 105 may be network addressable computers configured to act as a transaction intermediary to facilitate the exchange of data over the network 114 corresponding to user transactions. User transactions may include receiving and processing item and item related data and user data from a multitude of users, such as payment data, shipping data, item review data, feedback data, and any other suitable data communicated between parties to a transaction. A transaction intermediary such as the sales channels 104, 105 may include one or all of the functions associated with a shipping service broker, payment service, and other functions associated with transactions between one or more parties. For simplicity, these functions are discussed as being an integral part of the network based sales channel 104, 105; however, it is to be appreciated that these functions may be provided by systems remotely and/or decoupled from the network based sales channel 104, 105.

Merchant device 106 may be any suitable computing device that allows a merchant to exchange data with the inventory exchange 108 over the network 114. In some embodiments, the merchant device 106 may execute a web-based client or web-based application capable of providing a merchant with a user interface (UI) that displays a number of inventory management functions to the merchant. For example, such a UI may display UI elements for configuring an inventory (e.g., defining a number of items in the inventory, item pricing, a name for the inventory, storage locations, shipping options, item descriptions, and the like) and defining one or more business rules to be applied to the inventory. The operations involved in configuring an inventory and defining the one or more business rules is explained in greater detail below.

The inventory exchange 108 may be a network-based computing device configured to manage an inventory of a merchant across multiple sales channels (e.g., sales channels 104, 105). As described above, the inventory exchange 108 may be configured to exchange data with the merchant device 106 to distribute the inventory of the merchant across the multiple sales channels (e.g., sales channels 104, 105) according to the one or more business rules defined by the merchant. For example, according to one example embodiment, the inventory exchange 108 may distribute a first set of items from the inventory by listing those items on sales channel 104. Inventory exchange 108 may further distribute a second set of items from the inventory by listing those items on sales channel 105. The distribution of the first set of items and the second set of items may be performed in accordance to one or more of the business rules defined by the merchant.

The inventory exchange 108 may be configured further to exchange data with the sales channels 104, 105 to enforce the one or more business rules configured by the merchant. For example, a consumer using the consumer device 102 may purchase an item from the inventory through sales channel 104. In some cases, the purchase of the item may cause the distribution of the inventory across the multiple sales channels to deviate from a business rule defined by the merchant. Accordingly, inventory exchange 108 may remove one or more listings from one sales channel and list one or more items on another sales channel until the distribution of the inventory is in accordance with the business rules defined by the merchant. The term “rebalance,” as used herein, may refer to the process of updating the items listed on multiple sales channels so that distribution of the items in an inventory is in accordance with the business rules defined by the merchant.

Although FIG. 1A illustrates a particular example of the arrangement of the consumer device(s) 102, the sales channels 104, 105, the merchant device 106, the inventory exchange 108, and the network 114, this disclosure includes any suitable arrangement or configuration of the consumer device(s) 102, the sales channels 104, 105, the merchant device 106, the inventory exchange 108, and the network 114. For example, FIG. 1B is a network diagram depicting an event system 10, consistent with some embodiments described herein, configured to manage an inventory across multiple sales channels using an event driven architecture. The event system 10 may include one or more network based sales channels, such as the network based sales channels 104, 105 described above. Responsive to consumers purchasing item through the sales channels 104, 105 via consumer device 102, the sales channels 104, 105 may communicate order events to a capability through a message bus 30. A “capability,” as used herein, may refer to an application that is configured to receive (subscribe) and send (publish) messages through the message bus 30. FIG. 1B shows that the inventory exchange 108 may be configured to operate as a capability that subscribes and publishes messages through the message bus 30 to the sales channels 104, 105. In some embodiments, the inventory exchange 108 provides a unified interface for a merchant device 106 to manage an inventory sold across the sales channels 104, 105.

### Exemplary Data Flow

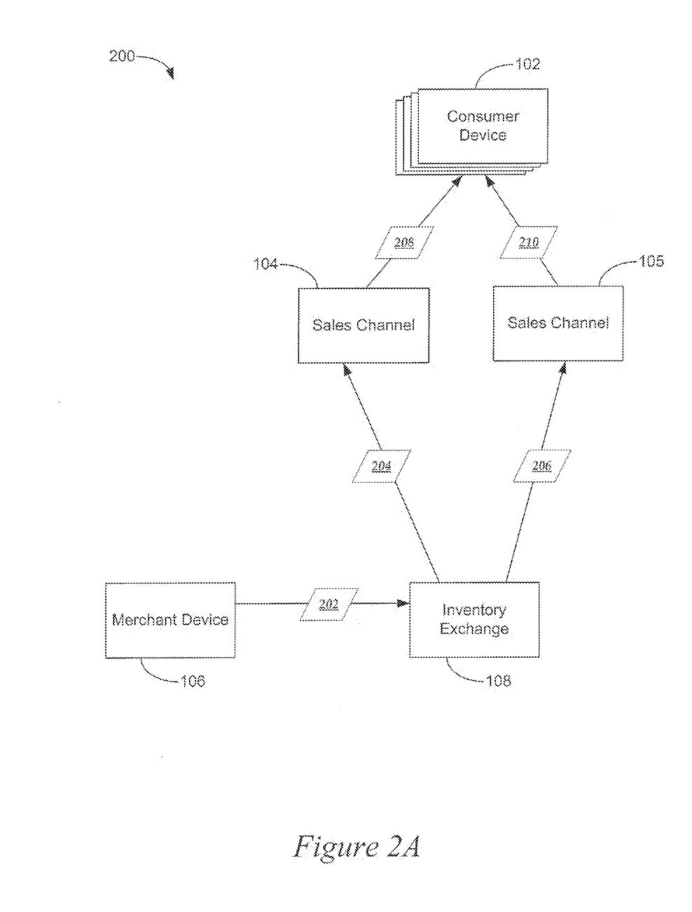

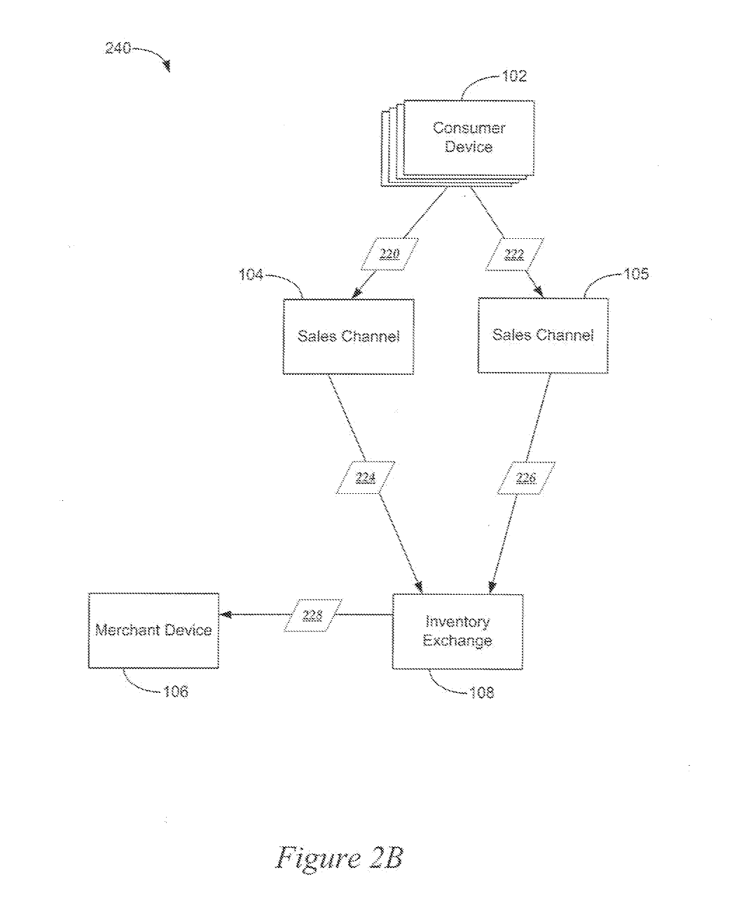

FIG. 2A is a block diagram illustrating a data flow 200 to initiate an inventory management service across multiple sales channels, according to some embodiments. The data flow 200 may begin when the merchant device 106 communicates inventory configuration data 202 to the inventory exchange 108. The inventory configuration data 202 may include data that define or otherwise characterize an inventory, such as an item count, item location, and the like. Further, the inventory configuration data 202 may include one or more business rules. The business rules may define or otherwise characterize how items within the inventory will be managed across multiple sales channels. Although the business rules are described in greater detail below, a few business rules are now provided for the purpose of illustration but not limitation. For example, a business rule that sets forth how the inventory is partitioned among the multiple sales channels (e.g., 40% of the inventory to sales channel 104, 60% of the inventory to sales channel 105) is an example of a business rule that a merchant may configure to be applied to an inventory. Further, a pricing rule that defines how items will be priced relative to a particular sales channel is another example of a business rule that a merchant may configure to be applied to an inventory.

After the inventory exchange 108 receives the inventory configuration data 202, the inventory exchange 108 then uses the business rules to manage inventory across the multiple sales channels. For example, the inventory exchange 108 may use the business rule discussed above to list a first set of items on the sales channel 104 and a second set of items on the sales channel 105 by sending listing data 204, 206 to the respective sales channel. The listing data 204, 206 may include, in some embodiments, a subset of the data provided by the inventory configuration data 202, such as a product name, product images, a price, and the like. A price used to list the items on the respective sales channel may be determined, according to some embodiments, based on a business rule that specifies a pricing function for sales channel 104 and sales channel 105.

After the items of the inventory are listed on sales channels 104, 105 according to the business rules selected by the merchant, the sales channels 104, 105 may then provide listings 208, 210 of the various items of the inventory to one or more consumer devices, such as the consumer device 102 of FIG. 1. The listings 208, 210 provided by the sales channel 104, 105 represent items that a consumer may purchase through the multiple sales channels.

FIG. 2B is a block diagram illustrating a data flow 240 for managing an inventory management service across multiple sales channels, according to some embodiments. The data flow 240 may begin when the sales channels 104, 105 receive transaction data 220, 222 from the consumer device 102. The transaction data 220, 222 may include data that indicates that one or more consumers have purchased one or more items associated with the inventory. For example, the transaction data 220 may relate to an order for X items from the inventory, while the transaction data 222 may relate to an order of Y items from the inventory.

Responsive to receiving the transaction data 220, the sales channel 104 may then generate a corresponding order event 224 that corresponds to the transaction data 220. The order event 224 is a message that signifies that a particular order has been placed on the inventory. In some embodiments, an order event may include a quantity, product identifier, price, geographic location, or some combination thereof. Further, the order event 224 may include data that relates a transaction with an inventory, such as a subscription identifier, inventory identifier, merchant identifier, or the like.

Alternatively or additionally, responsive to receiving the transaction data 222, the sales channel 105 may generate a corresponding order event 226 that corresponds to the transaction data 222. The order event 226 is a message that signifies that a particular order has been placed on the inventory. In some embodiments, an order event may include a quantity, product identifier, price, geographic location, or some combination thereof.

As FIG. 2B shows, the sales channels 104, 105 send the order events 222, 224, respectively, to the inventory exchange 108. Upon receiving the order events 222, 224, the inventory exchange 108 then updates inventory tracking data that indicates a current distribution of the items associated with the inventory of a merchant. The inventory exchange 108 may utilize the inventory tracking data to rebalance, using one or more business rules, the items listed on sales channels 104, 105. For example, the inventory exchange 108 may remove some items listed on sales channel 105 and relist those items on sales channel 104 if the distribution of items violates a business rule defined by the merchant.

It is to be appreciated that in some cases the inventory exchange 108, once configured by the merchant device 106, may operate independent of any involvement of the merchant. For example, the rebalancing of an inventory may occur in substantially real-time in response to receiving order events 224 from the various sales channels.

### Exemplary Modules

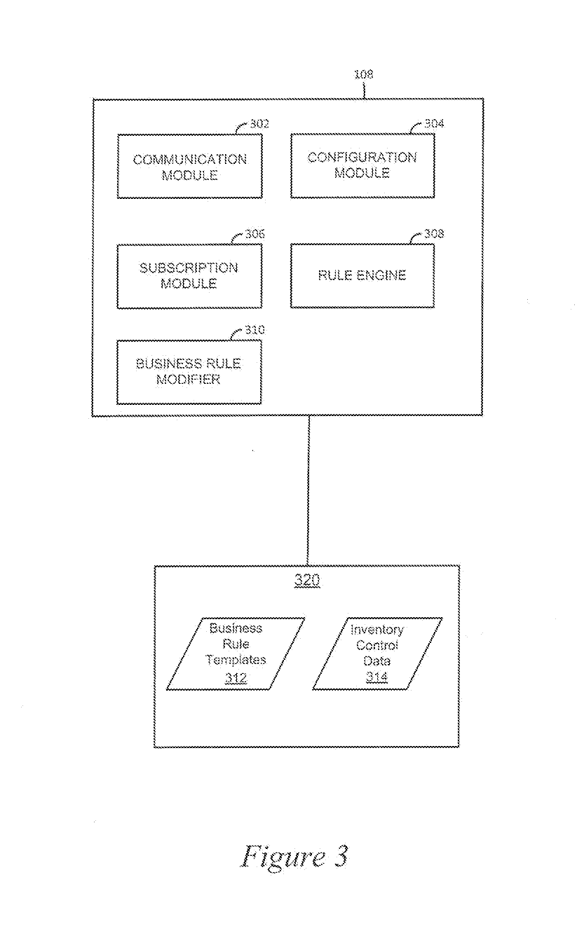

FIG. 3 is a block diagram illustrating example modules and data of the inventory exchange 108, according to some embodiments. For example, FIG. 3 shows that the inventory exchange 108 includes a communication module 302, a configuration module 304, a subscription module 306, a rule engine 308, and a business rule modifier 310.

The communication module 302 may be configured to receive and transmit data and/or commands to and from the various components of the transaction system 100.

The configuration module 304 may be configured to generate an interface (or interfaces) to a merchant that allow the merchant to define or specify properties associated with an inventory and corresponding business rules. For example, the configuration module 304, according to some embodiments, may generate an electronic form or menu that allows a user (e.g., a merchant) to specify listing data (e.g., an image, description, purchasing and shipping terms, and the like) and a quantity associated with an inventory. Further, as will be described in greater detail below, the configuration module 304, according to some embodiments, may generate an electronic form or menu that allows a user (e.g., a merchant) to specify business rules that may be used to manage the inventory across multiple sales channels.

The subscription module 306 may be configured to subscribe the inventory exchange 108 with a particular sales channel (e.g., sales channels 104, 105). Once subscribed, the sales channels will communicate order events to the inventory exchange 108 when an item from the inventory is purchased through the sales channel. Consistent with various embodiments described herein, when an inventory exchange 108 subscribes to a sales channel, the subscription may be for a specific merchant, listing, category of listing, or combination thereof. In this way, the subscription module 306 may limit the processing of order events to those order events that are relevant to the inventory items managed by the inventory exchange.

The rule engine 308 may be configured to apply one or more business rules to control how the items of an inventory are managed. By way of example and not limitation, one or more business rules may control the management of items of an inventory by setting rules for distributing the items across multiple sales channels, pricing items across multiple sales channels, generating reports for the merchant, setting trigger conditions for rebalancing the inventory, and the like. The operation of the business rules are described in greater detail below.

The business rule modifier 310 may be configured to update one or more business rules based on order events received from the multiple sales channels. For example, as is explained in greater detail below, the business rule modifier 310 may update a distribution of items from the inventory across the multiple sales channels based on a sell through rate of each of the multiple sales channels. Further, the business rule modifier 310 may update the sale price of the items of an inventory based on transaction revenue from each of the multiple sales channels.

FIG. 3 also shows that the inventory exchange 108 may be communicatively coupled to a database 320 to access business rule templates 312 and inventory control data 314. In some embodiments, the business rules templates 3112 are generic rule templates that are available for a merchant to use to define an inventory management strategy across multiple sales channels. Such generic rule templates may be customized by the merchant to incorporate inventory specific values (e.g., distribution value for the multiple sales channels, rebalancing thresholds, etc.). In other embodiments, the business rule templates 312 may include logic and or data that determine a business rule programming language. Merchants may use such business rule programming languages to define customized business rules that form an inventory management strategy across multiple sales channels.

The inventory control data 314 may include data that represents a merchant defined inventory control strategy for an inventory. For example, in some embodiments, the inventory control data 314 may include an inventory profile submitted by the merchant and one or more business rules that are to be applied to the inventory profile. As described above, an inventory profile may include data that characterizes the items of the inventory, such as an item count, location, image, description, and purchasing and shipping terms.

It should be appreciated that, in other embodiments, the inventory exchange 108 may include fewer, more, or different modules apart from those shown in FIG. 3. For example, in an alternate embodiment, any one of the communication module 302, configuration module 304, subscription module 306, and rule engine 308 may be combined into a single module. In another embodiment, the communication module 302, configuration module 304, subscription module 306, and rule engine 308 may be separate from and executed or processed in parallel with each other.

### Exemplary Methods

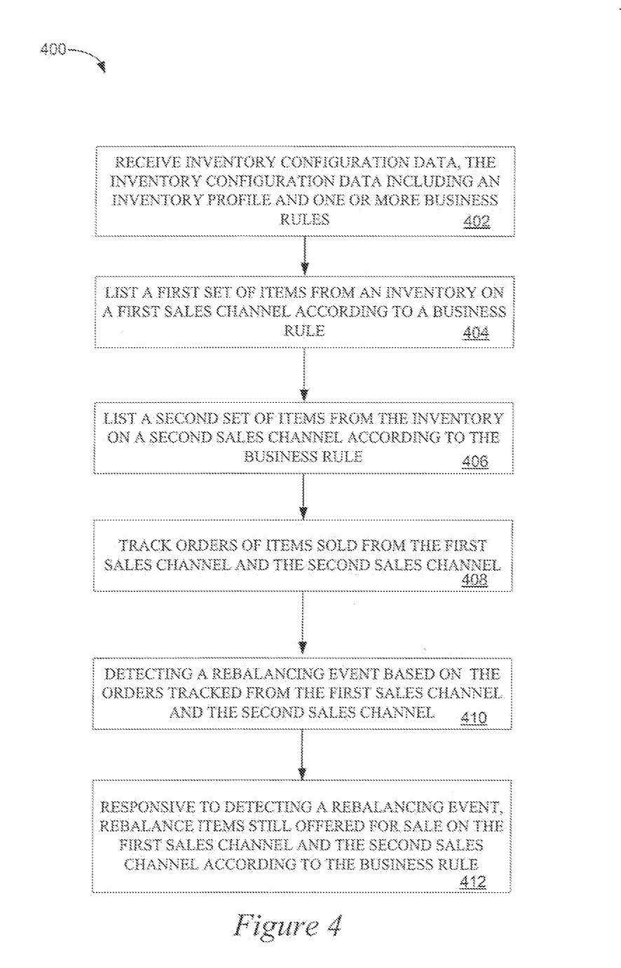

FIG. 4 is a flow chart illustrating a method 400 of managing an inventory across multiple sales channels, according to an example embodiment. In an embodiment, the method 400 may be implemented by the components, modules, and data shown in FIGS. 1A, 1B, 2A, 2B, and 3 and, accordingly, is described by way of example with reference thereto.

The method 400 may begin at operation 402 when the communication module 302 receives inventory configuration data 202 from the merchant device 106. As described above, the configuration data 202 may include an inventory profile and one or more business rules. By way of example and not limitation, the inventory profile may specify that the inventory includes ‘X’ items that are to be listed on the sales channel 104 and the sales channel 105 according to a 40%/60% distribution. That is, 0.4*‘X’ items will be listed on sales channel 104, and 0.6*‘X’ items will be listed on sales channel 105.

After the configuration data 202 is received, the rule engine 308 may then list a first set of items from the inventory on a first sales channel according to the business rule. This is shown as operation 404. For example, based on the inventory profile and business rule set forth above, the rule engine 308 will list 40% of the ‘X’ items from the inventory of the merchant on sales channel 104.

At operation 406, the rule engine 308 may then list a second set of items from the inventory on a second sales channel according to the business rule. For example, with continued reference to the example business rule set forth above, the rule engine 308 will list 60% of the items in the inventory of the merchant on sales channel 105. It is to be appreciated that using the business rule to list some items on one sales channel and another set of items on another sales channel may operate in a manner that does not double list an item. That is, a single item is not listed on both the sales channels.

At operation 408, the subscription module 306 may track orders of items sold from the first sales channel and the second sales channel. In some embodiments, tracking orders may involve receiving order events (e.g., order events 224, 226 shown on FIG. 2B) received from the sales channels 104, 105. The order events, in some cases, may include transactional data such as an item identifier, listing identifier, merchant identifier, subscription channel identifier, and the like. Using the transactional data, the subscription module 306 may update the inventory control data 314 on FIG. 3 to update the number of items in the inventory that are still available for sale.

At operation 410, the rule engine 308 may detect a rebalancing event based on the orders tracked from the first sales channel (e.g., sales channel 104) and the second sales channel (e.g., sales channel 105). As used herein, the term “rebalancing event” may refer to a determinable condition that signifies that a merchant's inventory is to be rebalanced according to a business rule. In some embodiments, the determinable condition is specified as part of the business rule or during the configuration process. For example, a business rule may specify that the business rule is to be triggered to rebalance an inventory when the distribution of inventory is outside an acceptable range. Where a business rule specifies a distribution ratio, such as 40% of the inventory is to be listed on a first sales channel and 60% is to be listed on a second sales channel, the business rule may specify that the inventory is to be rebalanced when either of the distributions of the inventory on sales channels differs from the specified distribution ratio. In some other embodiments, the rule engine 308 may monitor for a rebalancing event after each order event. Other conditions for a rebalancing event are described in greater detail below.

At operation 412, responsive to the detected the rebalancing event, the rule engine 308 may rebalance the items still offered for sale on the first sales channel and the second sales channel. Continuing with the example business rule described above, the rule engine 308 may delist a number of items on the second sales channel and list items on the first sales channel until the 40%-60% distribution ratio is achieved, or at least substantially achieved by some determinable margin.

It is to be appreciated that some embodiments may be configured to manage the distribution of listing of items across a number of sales channels without merchant intervention. It is to be further appreciated that some embodiments may operate by receiving confirmation from the merchant before proceeding with the rebalance of the inventory.

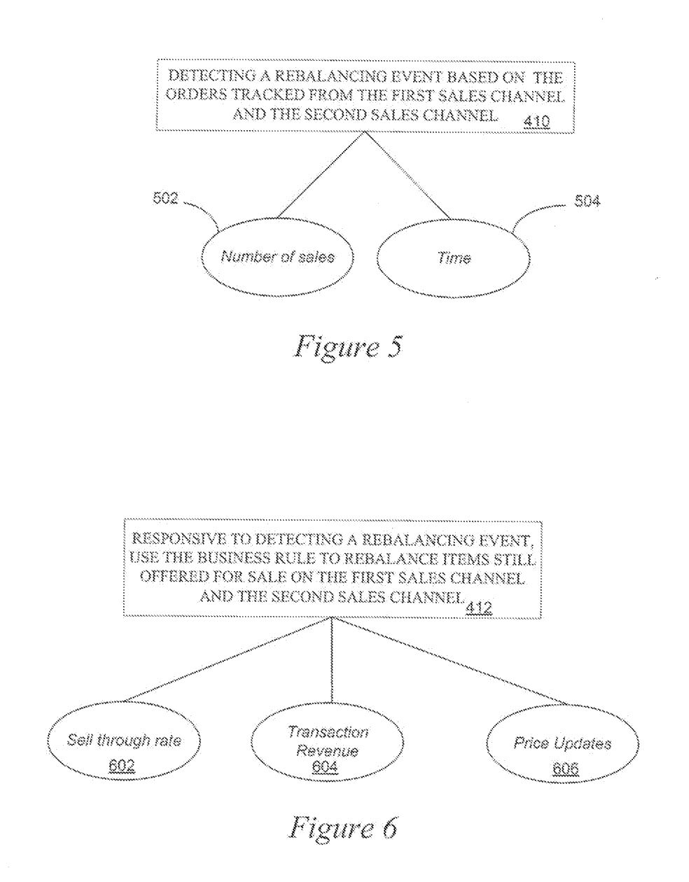

FIG. 5 is a diagram that shows a number of conditions that may be used by example embodiments to determine whether to perform operation 410 of FIG. 4. In some embodiments, the rule engine 308 detects the conditions shown in FIG. 5.

For example, condition 502 of FIG. 5 shows that a number of sales may be used to trigger the rules engine 308 to detect a rebalancing event. For example, as described above, a merchant may use a business rule to define a distribution ratio between a multitude of sales channels. For instance, the merchant might configure a rule that specifies a distribution ratio that partitions 10% of the inventory to a first sales channel, 20% of the inventory to a second sales channel, 15% of the inventory to a third sales channel, and so forth. In some embodiments, the inventory exchange 108 may rebalance the inventory after receiving a determinable number of order events (e.g., 1, 5, 10).

Condition 504 of FIG. 5 shows that time may also be a condition used to trigger the rules engine 308 to detect a rebalancing event. For example, the rule engine 308 may rebalance the inventory after a determinable amount of time has elapsed since a prior rebalance event. In this way, rather than rebalancing after receiving every order event or every number of order events, the rule engine 308 will wait for a determinable amount of time, as may be configured, and then rebalance the inventory as specified by a business rule.

It is to be appreciated that such conditions based on time and number of items in an inventory may be used in combination. For example, the inventory exchange may be configured to rebalance whenever a timing condition or quantity based condition has been met.

In some example embodiments, the operation of rebalancing an inventory (operation 412 of FIG. 4) may include modifying a business rule supplied by a merchant based on historical order events received from multiple sales channels. FIG. 6 is a diagram showing various conditions used to update a business rule, according to an example embodiment. In discussing FIG. 6, the example business rule discussed above will be used to clarify the operations of the business rule modifier 310. That is, as discussed above, a merchant may define a business rule that initially specifies that 40% of the inventory is to be listed on a first sales channel and 60% of the inventory is to be listed on a second sales channel.

In one embodiment, the business rule modifier 310 uses a sell through rate-based approach for business rule modification. This is shown as condition 602. In the sell through rate-based approach, the business rule modifier 310 may trigger based on a determinable condition (e.g., based on a configured time or quantity of sold items). Once triggered, the business rule modifier 310 may calculate a sell through rate to determine an adjustment value to be applied to the distribution ratio specified by the business rule. By way of example and not limitation, assume that a merchant configures the inventory exchange 108 to manage an inventory for a given stock keeping unit (SKU) number. The inventory may initially have 1000 items, and the initial business rule may partition the inventory so that 500 items are listed in each of a first sales channel and a second sales channel. Still further, the merchant may configure the inventory exchange 108 to wait until 100 items are sold before updating the business rule. As a simple example, out of the first 100 items sold through the first sale channel and the second sales channel, the first sales channel may have sold 70 items and the second sales channel may have sold 30 items. Accordingly, the business rule modifier 310 may be configured to update the business rule so that the distribution matches the historical sell through rate. That is, the business rule modifier 310 may update the business rule so that 70% of the inventory is listed via the first sales channel and 30% of the inventory is listed via the second sales channel. Also note that other example embodiments may update the business rule after a configured time period has elapsed rather than a quantity of items being sold (e.g., 100 items), or some combination of a time period and/or quantity of items being sold.

In some embodiments, the business rule modifier 310 may use a machine learning based approach that uses transactional revenue to update the business rule. This is shown as condition 604. The term “transaction revenue,” as used herein, may refer to a compensation the merchant receives for selling an item through a sales channel. Transactional revenue may include data relating to a profit obtained per order, fees per transaction, or overhead costs (e.g., the expected cost of keeping the inventory, as may be calculated using an average time to sell an item through a give sales channel).

The transaction revenue and sell through rate associated with each sales channel may be used by the business rule modifier 310 to calculate an adjustment to a business rule. For example, relative to the sales through rate or transaction revenue, the business rule modifier 310 may update a distribution of the inventory so that the number of items listed on one sales channel is increased and the number of items listed on another sales channel is decreased.

In some embodiments, the inventory management system may be configured to update a business rule based on price adjustments occurring across multiple sales channels. This is shown as condition 606. For example, a merchant may configure a threshold price for items of an inventory that are sold on a specific sales channel. The inventory management system may then subscribe to multiple sales channels to receive price change events. Price change events may indicate a price change for similar items sold by competitor merchants. In one way, one item is similar to another item when they share a common category.

When items are sold or sold on the multiple sales channels, the inventory management system may receive price change events through the subscription module 306 of FIG. 3. A price change event may specify a new price of an item that is similar to the items of the inventory. In some embodiments, an order event may represent a price change event.

Using on a price adjustment function, the business rule modifier 310 of the inventory exchange 108 may adjust the price on the item listing. For example, the business rule modifier 310 may determine that the price specified by the price change event is greater than the price threshold but less than the price of the listed item. In response to this determination, the inventory management system may update the listed item to reflect a new price that is a function of the price specified in the price change event (e.g., a price that is lower than the competition). This rule can be one of the triggers in a chain of configured rules in addition to time period and inventory condition mentioned above.

### Modules, Components, and Logic

Additionally, certain embodiments described herein may be implemented as logic or a number of modules, components, or mechanisms. A module, logic, component, or mechanism (collectively referred to as a “module”) may be a tangible unit capable of performing certain operations and is configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by cost and time considerations.

Accordingly, the term module should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Electronic Apparatus and System

Exemplary embodiments may be implemented in analog, digital, or hybrid electronic circuitry, or in computer hardware, firmware, software, or in combinations thereof. Exemplary embodiments may be implemented using a computer program product, for example, a computer program tangibly embodied in an information carrier (e.g., in a machine-readable medium for execution by, or to control the operation of, data processing apparatus, for example, a programmable processor, a computer, or multiple computers).

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

In certain exemplary embodiments, operations may be performed by one or more programmable processors executing a computer program to perform functions by operating on input data and generating output. Method operations can also be performed by, and apparatus of exemplary embodiments may be implemented as, special purpose logic circuitry (e.g., a field programmable gate array (FPGA) or an application-specific integrated circuit (ASIC)).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination permanently and temporarily configured hardware may be a design choice. Below are set out hardware (e.g., machine) and software architectures that may be deployed, in various exemplary embodiments.

### Exemplary Machine Architecture and Machine-Readable Medium

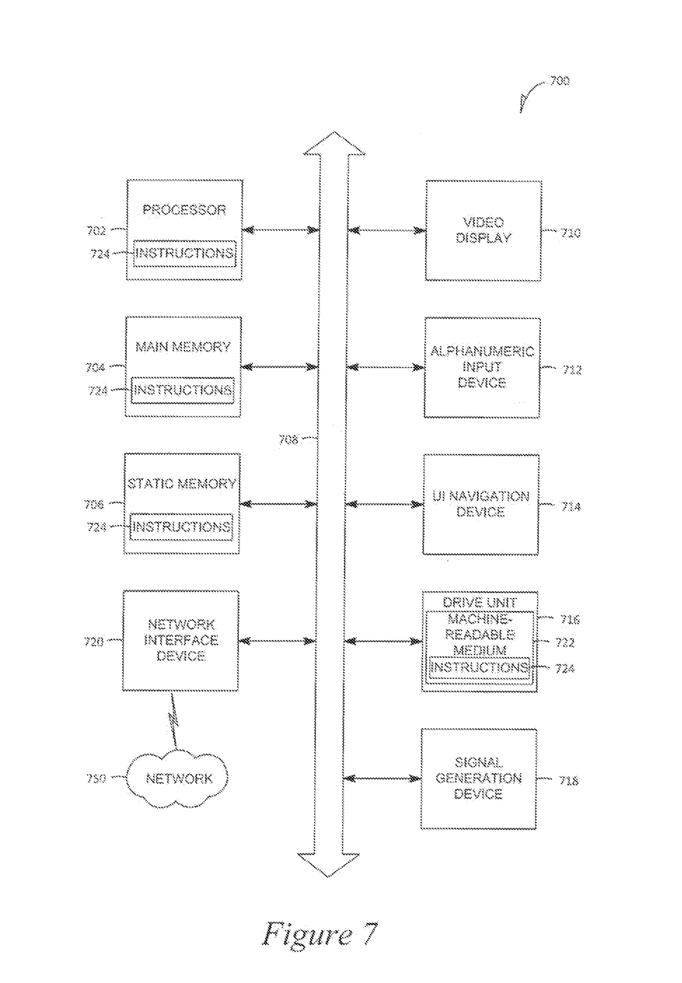

With reference to FIG. 7, an exemplary embodiment extends to a machine in the exemplary form of a computer system 700 within which instructions, for causing the machine to perform any one or more of the methodologies discussed herein, may be executed. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a UI navigation device 714 (e.g., a mouse), a disk drive unit 716, a signal generation device 718 (e.g., a speaker), and a network interface device 720.

### Machine-Readable Medium

The disk drive unit 716 includes a machine-readable medium 722 on which is stored one or more sets of instructions and data structures (e.g., software 724) embodying or utilized by any one or more of the methodologies or functions described herein. The software 724, 706 may also reside, completely or at least partially, within the main memory 704 or within the processor 702 during execution thereof by the computer system 700; the main memory 704 and the processor 702 also constituting machine-readable media.

While the machine-readable medium 722 is shown in an exemplary embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of exemplary semiconductor memory devices (e.g., EPROM, EEPROM, and flash memory devices); magnetic disks such as internal hard disks and removable disks; magneto-optical disks; and CD-ROM and DVD-ROM disks.

### Transmission Medium

The software 724 may further be transmitted or received over a communications network 750 using a transmission medium via the network interface device 720 utilizing any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

### Exemplary Three-Tier Software Architecture

In some embodiments, the described methods may be implemented using a distributed or non-distributed software application designed under a three-tier architecture paradigm. Under this paradigm, various parts of computer code (or software) that instantiate or configure components or modules may be categorized as belonging to one or more of these three tiers. Some embodiments may include a first tier as an interface (e.g., an interface tier). Further, a second tier may be a logic (or application) tier that performs application processing of data input through the interface level. The logic tier may communicate the results of such processing to the interface tier or to a backend or storage tier. The processing performed by the logic tier may relate to certain rules or processes that govern the software as a whole. A third storage tier may be a persistent storage medium or a non-persistent storage medium. In some cases, one or more of these tiers may be collapsed into another, resulting in a two-tier architecture or even a one-tier architecture. For example, the interface and logic tiers may be consolidated, or the logic and storage tiers may be consolidated, as in the case of a software application with an embedded database. The three-tier architecture may be implemented using one technology or a variety of technologies. The exemplary three-tier architecture, and the technologies through which it is implemented, may be realized on one or more computer systems operating, for example, as a standalone system, or organized in a server-client, peer-to-peer, distributed, or some other suitable configuration. Further, these three tiers may be distributed between more than one computer system as various components.

### Components

Exemplary embodiments may include the above described tiers, and processes or operations about constituting these tiers may be implemented as components. Common to many of these components is an ability to generate, use, and manipulate data. The components, and the functionality associated with each, may form part of standalone, client, server, or peer computer systems. The various components may be implemented by a computer system on an as-needed basis. These components may include software written in an object-oriented computer language such that a component-oriented or object-oriented programming technique can be implemented using a Visual Component Library (VCL), Component Library for Cross Platform (CLX), JavaBeans (JB), Enterprise JavaBeans™ (EJB), Java Messaging Services (JMS), MQ Series, Component Object Model (COM), Distributed Component Object Model (DCOM), or any other suitable technique.

Software for these components may further enable communicative coupling to other components (e.g., via various APIs), and may be compiled into one complete server, client, or peer software application. Further, these APIs may be able to communicate through various distributed programming protocols as distributed computing components.

### Distributed Computing Components and Protocols

Some exemplary embodiments may include remote procedure calls being used to implement one or more of the above described components across a distributed programming environment as distributed computing components. For example, an interface component (e.g., an interface tier) may form part of a first computer system that is remotely located from a second computer system containing a logic component (e.g., a logic tier). These first and second computer systems may be configured in a standalone, server-client, peer-to-peer, or some other suitable configuration. Software for the components may be written using the above described object-oriented programming techniques and can be written in the same programming language or a different programming language. Various protocols may be implemented to enable these various components to communicate regardless of the programming language used to write these components. For example, a component written in C++ may be able to communicate with another component written in the Java programming language through utilizing a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model or Transmission Control Protocol/Internet Protocol (TCP/IP) protocol stack model for defining the protocols used by a network to transmit data.

### A System of Transmission Between a Server and Client

Exemplary embodiments may use the OSI model or TCP/IP protocol stack model for defining protocols used by a network to transmit data. In applying these models, a system of data transmission between a server and client, or between peer computer systems, may, for example, include five layers comprising: an application layer, a transport layer, a network layer, a data link layer, and a physical layer. In the case of software for instantiating or configuring components having a three-tier architecture, the various tiers (e.g., the interface, logic, and storage tiers) reside on the application layer of the TCP/IP protocol stack. In an exemplary implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data are transmitted over a network such as an internet, LAN, WAN, or some other suitable network. In some cases, Internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology) or structures.

Although an embodiment has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually or collectively, by the term “invention” merely for convenience and without intending to voluntarily limit the scope of this application to any single invention or inventive concept if more than one is, in fact, disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

For example, particular embodiments describe various arrangements, algorithms, programming tools, and topologies of systems. A skilled artisan will recognize, however, that additional embodiments may be focused on performance and usability of the internal cloud infrastructure system.

These and various other embodiments are all within a scope of the example embodiments disclosed herein. The specification and drawings are, accordingly, to be regarded in an illustrative rather than a restrictive sense.

1. A method comprising:
listing, using one or more processors, a first quantity of items from an inventory on a first sales channel, the first quantity of items being determined according to a distribution ratio specified by a business rule;
listing, using the one or more processors, a second quantity of items from the inventory on a second sales channel, the second quantity of items being determined according to the distribution ratio specified by the business rule;
tracking, using the one or more processors, order events from the first sales channel and the second sales channel, the order events indicating a transaction involving an item from the inventory; and
responsive to detecting a rebalancing event, rebalancing, using the one or more processors, the items from the inventory still offered for sale on the first sales channel and the second sales channel according to the distribution ratio specified by the business rule.

2. The method of claim 1, wherein the business rule includes a first distribution of the inventory associated with the first sales channel and a second distribution of the inventory associated with the second sales channel.

3. The method of claim 2, further comprising adjusting the first distribution and the second distribution based on the order events tracked from the first sales channel and the second sales channel.

4. The method of claim 3, wherein the adjusted first distribution matches the sell through rate of the inventory associated with the first sales channel and the adjusted second distribution matches the sell through rate of the inventory associated with the second sales channel.

5. The method of claim 1, wherein the business rule further defines a first price usable for the first quantity of items being listed on the first sales channel and a second price usable for the second quantity of items being listed on the second sales channel.

6. The method of claim 5, further comprising adjusting the first price based on the order events tracked from the first sales channel.

7. The method of claim 1, wherein the order events are received through a message bus communicatively coupled to the first sales channel and the second sales channel.

8. The method of claim 1, wherein the rebalancing event is triggered based on a lapse of a determinable period of time.

9. The method of claim 1, wherein the rebalancing event is triggered based on receiving a determinable number of order events.

10. The method of claim 1, wherein rebalancing comprises:
removing one or more items from the first quantity of items from the first sales channel; and
relisting the one or more items removed from the first sales channel on the second sales channel.

11. A computer system comprising:
at least one processor;
a configuration module implemented by the at least one processor and configured to receive a business rule from a merchant; and
a rule engine module implemented by the at least one processor and configured to:
list a first quantity of items from an inventory on a first sales channel, the first quantity of items being determined according to a distribution ratio specified by the business rule;
list a second quantity of items from the inventory on a second sales channel, the second quantity of items being determined according to the distribution ratio specified by the business rule;
track order events from the first sales channel and the second sales channel, the order events indicating a transaction involving an item from the inventory; and
responsive to detecting a rebalancing event, rebalance the items from the inventory still offered for sale on the first sales channel and the second sales channel according to the distribution ratio specified by the business rule.

12. The computer system of claim 11, wherein the business rule includes a first distribution of the inventory associated with the first sales channel and a second distribution of the inventory associated with the second sales channel.

13. The computer system of claim 12, wherein the rule engine module is further configured to adjust the first distribution and the second distribution based on the order events tracked from the first sales channel and the second sales channel.

14. The computer system of claim 13, wherein the adjusted first distribution matches the sell through rate of the inventory associated with the first sales channel and the adjusted second distribution matches the sell through rate of the inventory associated with the second sales channel.

15. The computer system of claim 11, wherein the business rule further defines a first price usable for the first quantity of items being listed on the first sales channel and a second price usable for the second quantity of items being listed on the second sales channel.

16. The computer system of claim 15, wherein the rule engine module is further configured to adjust the first price based on the order events tracked from the first sales channel.

17. The computer system of claim 11, wherein the rebalancing event is triggered based on a lapse of a determinable period of time.

18. The computer system of claim 11, wherein the rebalancing event is triggered based on receiving a determinable number of order events.

19. The computer system of claim 11, wherein the rule engine module is configured to:
remove one or more items from the first quantity of items from the first sales channel; and
relist the one or more items on the second sales channel.

20. A non-transitory computer-readable medium storing executable instructions thereon, which, when executed by a processor, cause the processor to perform operations including:
listing a first quantity of items from an inventory on a first sales channel, the first quantity of items being determined according to a distribution ratio specified by a business rule;
listing a second quantity of items from the inventory on a second sales channel, the second quantity of items being determined according to the distribution ratio specified by the business rule;
tracking order events from the first sales channel and the second sales channel, the order events indicating a transaction involving an item from the inventory; and
responsive to detecting a rebalancing event, rebalancing the items from the inventory still offered for sale on the first sales channel and the second sales channel according to the distribution ratio specified by the business rule.
